(19) United States
(12) Patent Application Publication
(10) Pub. No.: US 2026/0296873 A1
(43) Pub. Date: Oct. 1, 2026

(54) SADDLE FOR HORSES

(71) Applicants: Sabrina POLANA, Tione di Trento (IT); Renato COVI, Borgo d’Anaunia (IT)

(72) Inventors: Sabrina POLANA, Tione di Trento (IT); Renato COVI, Borgo d’Anaunia (IT)

(21) Appl. No.: 19/489,811

(22) PCT Filed: Jun. 7, 2024
(86) PCT No.: PCT/IB2024/055574

§ 371 Date: Dec. 3, 2025

(30) Foreign Application Priority Data
Jun. 7, 2023 (IT) 102023000011547

(51) Int. Cl. B68C 1/04

(52) U.S. Cl. CPC B68C 1/04; B68C 2001/042

(57) ABSTRACT

A saddle for horses which comprises a base structure, which defines at least one resting region for a load, and at least one contact frame, having a longitudinal axis of extension, the contact frame supports a plurality of resting elements which are configured to face the horse in discrete regions; the contact frame comprises at least two parts which are arranged along the longitudinal axis of extension of the contact frame and support respective resting elements; at least one of the parts is movable relative to the base structure and is interconnected to the other one of the parts by means of the interposition of elastic elements and the resting elements are elastically movable, with respect to the contact frame, in order to accommodate the movements of the horse during its locomotion and adapt to the anatomy of the horse.

The present application is a U.S. national stage entry under 35 U.S.C. §371 of PCT International Patent Application No. PCT/IB2024/055574, filed Jun. 7, 2024, which in turn claims priority to Italian Patent Application No. 102023000011547, filed Jun. 7, 2023, the entirety of each of which are incorporated herein by reference.

The present invention relates to a saddle for horses.

As is known, saddles for horses have a saddle body which is designed to be placed on the back of the horse and which defines a seat for the rider.

In order to ensure the necessary stability of the rider and the health of the horse, the body of the saddle is structured so as to allow a uniform distribution of the weight of the rider, preventing excessive loads from being transmitted to the back of the horse, outside of the correct regions (referred to as the saddle support area or SSA).

Current saddles are typically made with an inner core, made of substantially rigid material, which constitutes the base structure on which the body of the saddle is built and which needs to have a shape and size adapted to the horse on which the saddle is intended to be used, in order to ensure the saddle rests correctly on the back of the horse.

Typically, in current saddles the body is made in a range of standard sizes and the possibility for adjustment is limited, so that it is not an easy matter to select the saddle that is perfectly suited to the horse.

As an alternative, bespoke saddles are available, which are made to measure for use on a specific horse.

However, in this case too, the growth of the horse over its lifetime means that over time the saddles are no longer usable.

Another drawback of current saddles derives from their rigidity which, although it gives a good distribution of the weight of the rider, unfortunately does not allow the saddle to sufficiently adapt to the movements made by the back of the horse during the ride.

It needs to be noted, furthermore, that typically the back of the horse is not symmetrical with respect to the longitudinal axis of the horse, and as a consequence this aspect means that current saddles are not perfectly adapted for all horses.

The aim of the present invention is to provide a saddle for horses that is capable of improving the known art in one or more of the above-mentioned aspects.

Within this aim, an object of the invention is to provide a saddle for horses that is capable of uniformly distributing the weight of the rider and, at the same time, of being perfectly adapted to the horse and to the movements of the horse during its locomotion.

Another object of the invention is to provide a saddle for horses that can easily adapt to the anatomical shape of the horse to be saddled.

Another object of the invention is to provide a saddle for horses that is capable of offering the highest guarantees of reliability and safety during its use.

Another object of the present invention is to provide a saddle for horses that is practical and convenient to use, in addition to being easy to dismount and transport.

Another object of the present invention is to provide a saddle for horses that is simple to provide in terms of construction.

Furthermore, the present invention sets out to overcome the drawbacks of the background art in a manner that is alternative to any existing solutions.

Another object of the invention is to provide a saddle for horses that, owing to its peculiar implementation characteristics, can also be competitive from an economic viewpoint.

This aim and these and other objects which will become better apparent hereinafter are achieved by a saddle for horses according to claim 1, optionally provided with one or more of the characteristics of the dependent claims.

Further characteristics and advantages of the invention will become better apparent from the description of preferred, but not exclusive, embodiments of the saddle according to the invention, illustrated by way of non-limiting example in the accompanying drawings wherein:

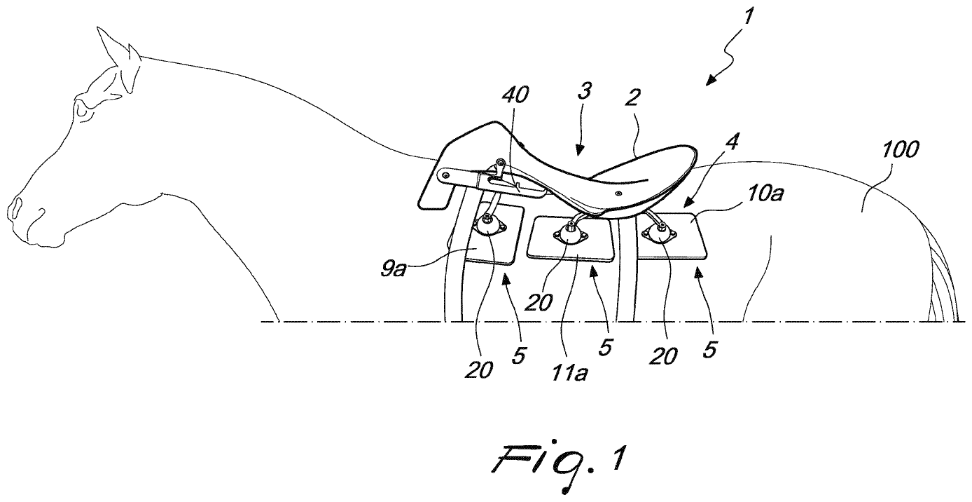

FIG. 1 is a side view of a saddle according to the invention applied on the back of a horse;

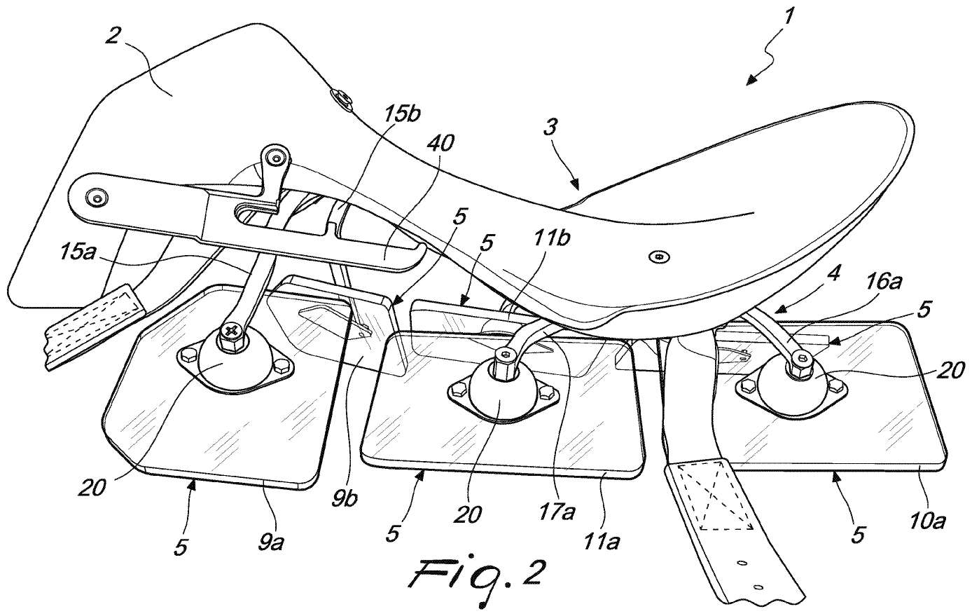

FIG. 2 is a side view of the saddle according to the invention;

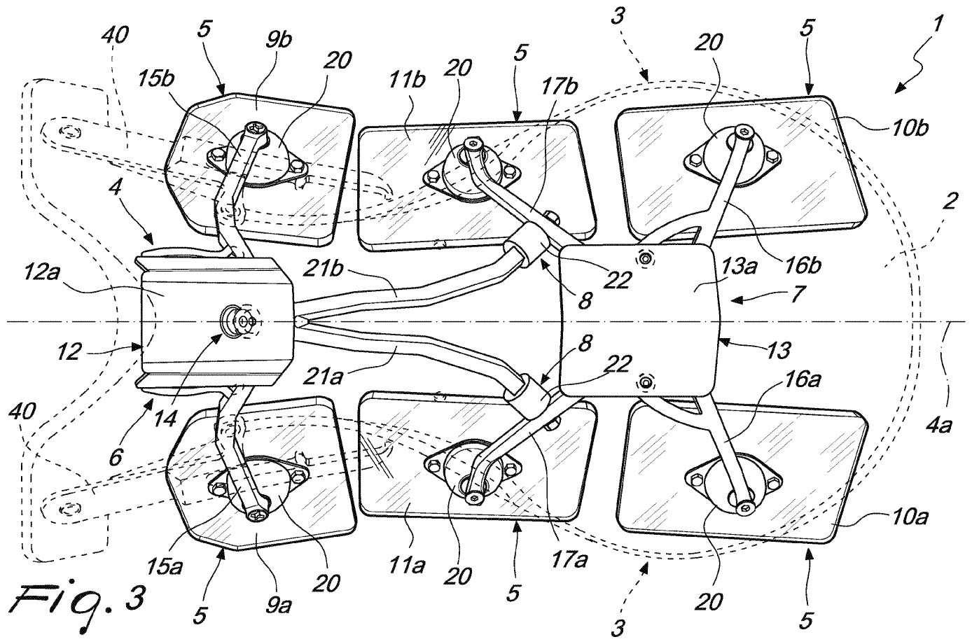

FIG. 3 is a plan view from above of the saddle according to the invention with a base structure of the saddle shown transparent in order to highlight a contact frame of the saddle;

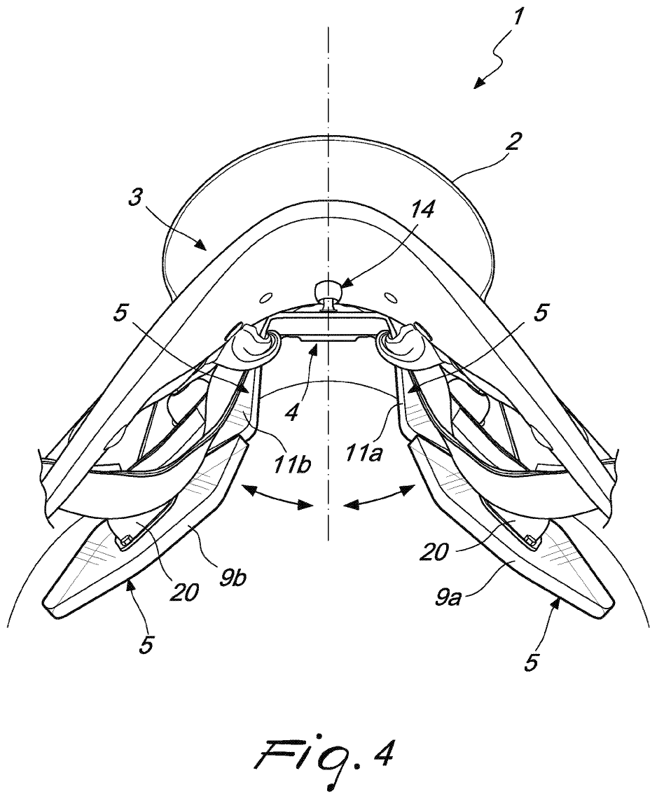

FIG. 4 is a front elevation view of the saddle according to the invention;

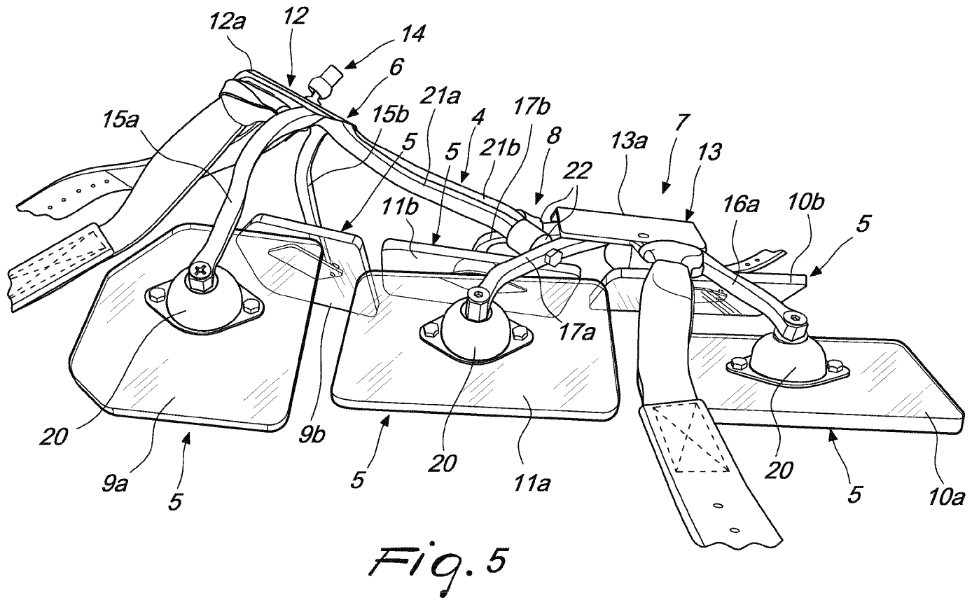

FIG. 5 is a side view of the saddle according to the invention with the base structure of the saddle removed in order to show the contact frame;

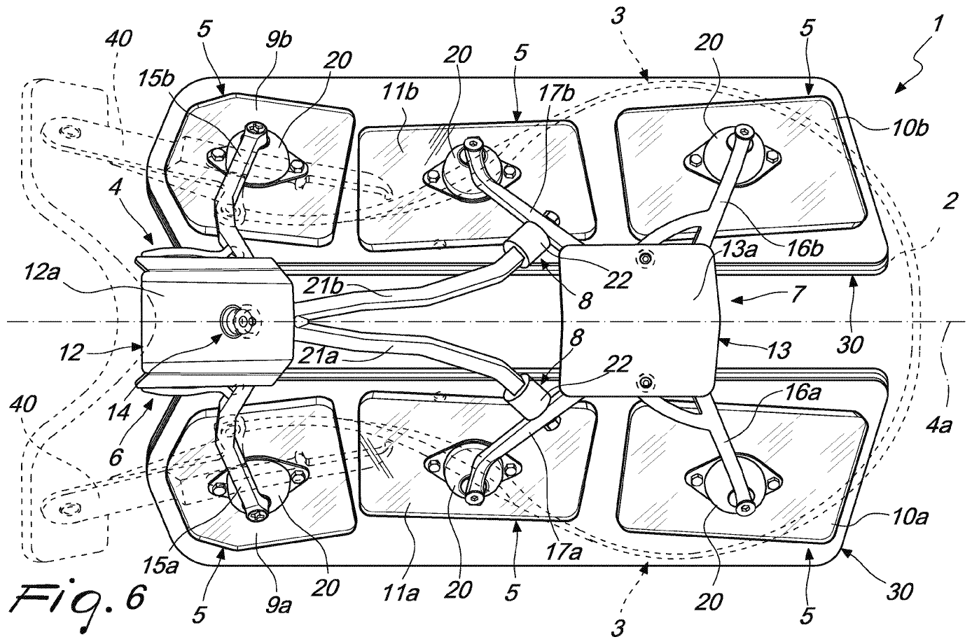

FIG. 6 is a plan view from above of another embodiment of the saddle according to the invention with the base structure of the saddle shown transparent;

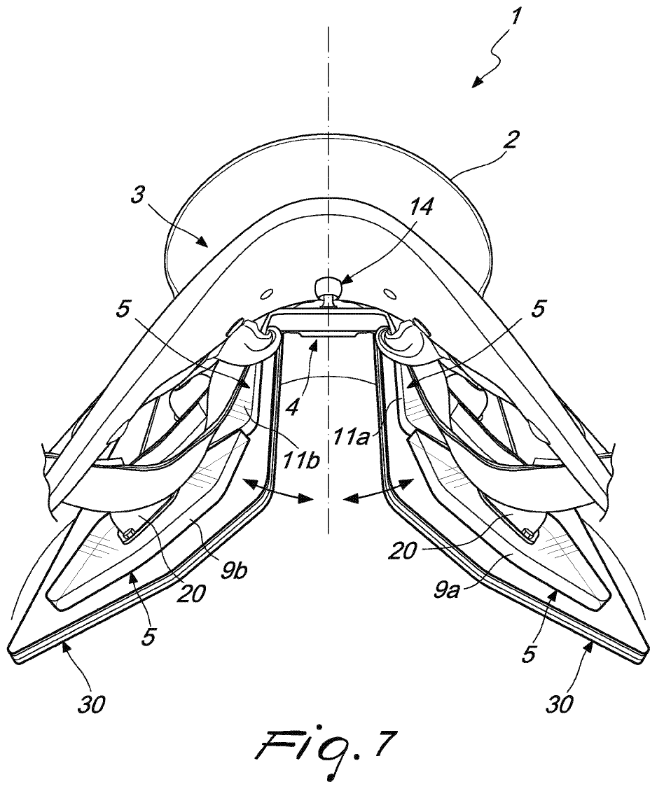

FIG. 7 is a front elevation view of the embodiment of the saddle according to the invention of FIG. 6;

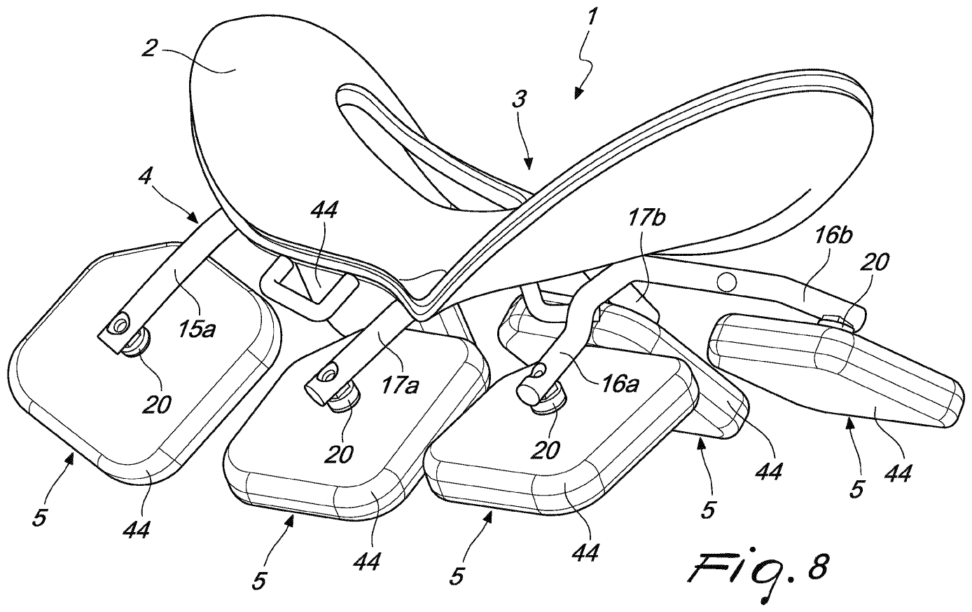

FIG. 8 is a perspective view of a variation of embodiment of the saddle according to the invention;

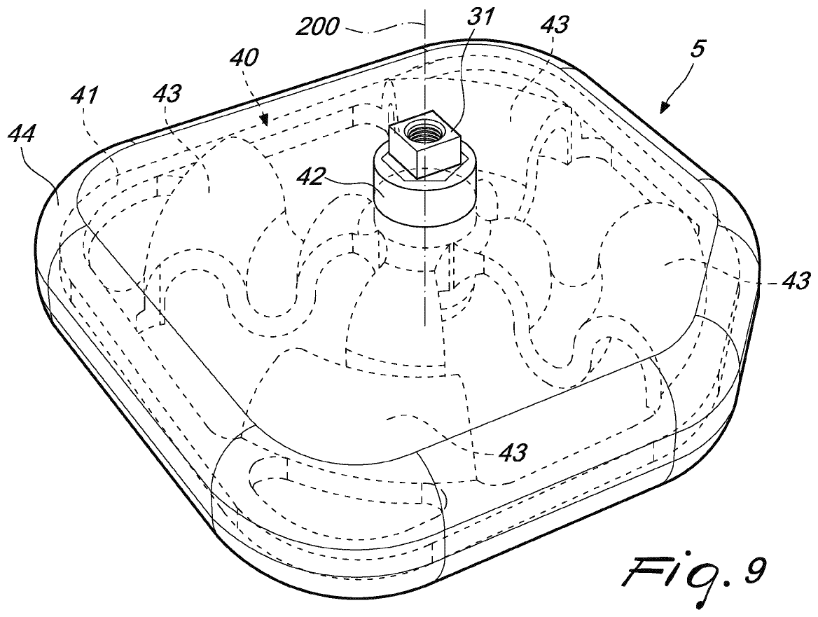

FIG. 9 is a transparent perspective view of a variation of embodiment of the resting element;

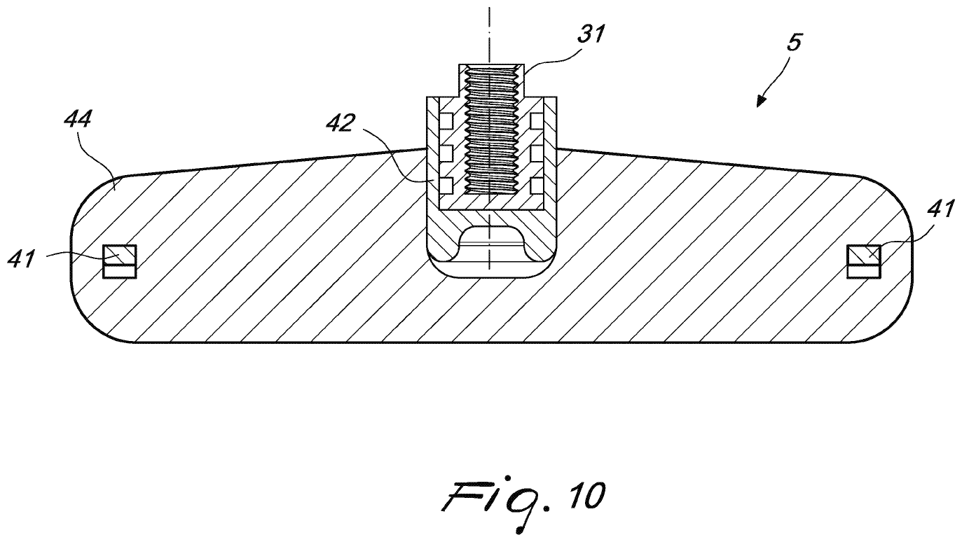

FIG. 10 is a cross-sectional view of the resting element of FIG. 9.

With reference to the figures, the saddle for horses according to the invention, generally designated by the reference numeral 1, comprises a base structure 2 intended to be applied on the back of a horse 100 to be saddled.

The base structure 2 defines, in general, at least one resting region for a load and, more specifically, a seat 3 for the rider, and has a longitudinal axis of extension that is substantially parallel to the longitudinal extension of the body of the horse 100 to be saddled.

The base structure 2 can be made of a substantially rigid material, so as to provide suitable characteristics of strength to the seat 3, and be, conveniently, covered by a covering layer of soft material, so as to render the seat 3 comfortable for the rider.

The saddle according to the invention further comprises a contact frame 4, which in use is interposed between the base structure 2 and the horse 100 to be saddled.

The contact frame 4 extends along a longitudinal axis of extension 4a which is arranged substantially parallel to the longitudinal extension of the body of the horse 100.

In particular, the contact frame 4 supports a plurality of resting elements 5, which are located on opposite sides with respect to the longitudinal axis of extension 4a of the contact frame 4 and which are configured to face the horse in discrete regions, so as to ensure an optimal adaptation of the saddle to the anatomical shape of the horse 100.

For example, the resting elements 5 are constituted by plates which are connected, on one of their faces, to the contact frame 4 and which are designed to face, on their opposite face, toward the back of the horse 100, in order to avoid causing pain and various diseases to the horse and, as a consequence, safeguard the psychological and physical well-being of the horse and rider.

As in the embodiment of FIGS. 6 and 7, at least one plate-like contact element 30 can be interposed between the resting elements 5 and the back of the horse and is elastically deformable, such as a cushion or a mat, optionally constituted by multiple different layers of suitable soft materials.

The function of such plate-like contact element 30 is to ensure a more uniform distribution of the weight loaded on the saddle and as a consequence a greater comfort for the horse.

For example, there are at least two plate-like contact elements 30, arranged on opposite sides with respect to the longitudinal axis of extension 4a of the frame 4.

Each one of such plate-like elements 30 is connected with the resting elements 5 arranged on the same side with respect to the longitudinal axis of extension 4a of the contact frame 4, preferably by means of removable connection means, such as, for example, tear-off elements, press-studs or other, similar elements.

More specifically, the resting elements 5 are elastically movable with respect to the contact frame 4, so as to be able to accommodate the movements of the horse 100 during its locomotion and adapt to the anatomy of the horse 100, and so make the saddle extremely comfortable for the horse 100 and at the same time ensure an optimal distribution of the weight of the rider on the horse.

According to the invention, the contact frame 4 comprises at least two parts 6 and 7, which are arranged along its longitudinal axis of extension 4a and which support respective resting elements 5.

Also according to the invention, at least one of the parts 6, 7 of the contact frame 4 can move, relative to the base structure 2, and is interconnected with the other part 6, 7 of the contact frame 4, by means of the interposition of elastic means 8, better described below, which are capable of exerting an elastic reaction to the movement of one of the two parts 6, 7 with respect to the other, so as to enable the contact frame 4, together with the resting elements 5, to follow the movements of the horse 100.

In particular, the parts 6, 7 of the contact frame 4 comprise, advantageously, at least one front part 6 and at least one rear part 7.

More specifically, the front part 6 of the contact frame 4 is articulated to the base structure 2 and supports at least one pair of front resting elements 9a, 9b, which are arranged mutually opposite with respect to the longitudinal axis of extension 4a of the contact frame 4, so as to be able to contact two front side regions of the back of the horse 100.

Conveniently, the front part 6 is articulated to the base structure 2 about multiple mutually perpendicular axes of rotation.

The rear part 7 of the contact frame 4 is, in turn, connected to the base structure 2 and supports at least one pair of rear resting elements 10a, 10b, which are arranged mutually opposite with respect to the longitudinal axis of extension 4a of the contact frame 4, in order to contact two rear side regions of the portion of the back of the horse 100 on which the saddle rests.

The rear part 7 of the contact frame 4 furthermore supports at least one pair of intermediate resting elements 11a, 11b, which are positioned, along the longitudinal axis of extension 4a of the contact frame 4, substantially between the front resting elements 9a, 9b and the rear resting elements 10a, 10b and which are arranged, in turn, so as to be mutually opposite, with respect to the longitudinal axis of extension 4a of the contact frame 4.

Conveniently, the front part 6 and the rear part 7 advantageously comprise respective supporting elements 12, 13, which are constituted for example by plate-like bodies 12a and 13a, which support respective supporting arms 15a, 15b, 16a, 16b, 17a, 17b which extend laterally in the opposite direction with respect to the longitudinal axis of extension 4a of the contact frame 4, and which in turn support, at their free ends, respective resting elements 5.

Advantageously, the resting elements 5 are connected to the respective supporting arms 15a, 15b, 16a, 16b, 17a, 17b by means of elastic joints 20 which ensure the resting elements 5 a certain mobility with respect to the supporting arms 15a, 15b, 16a, 16b, 17a, 17b, and an absorption of the loads that are transmitted from the saddle to the horse 100.

For example, such elastic joints 20 comprise a respective body made of elastically yielding material which is interposed between the resting elements 5 and the corresponding supporting arms 15a, 15b, 16a, 16b, 17a, 17b, and which, by virtue of its elastic deformability, allows the resting elements 5 to move with respect to the corresponding supporting arms 15a, 15b, 16a, 16b, 17a, 17b.

In greater detail, according to the embodiment shown, the front part 6 of the contact frame 4 is, basically, constituted by at least one front supporting element 12, which is arranged substantially at the longitudinal axis of extension 4a of the contact frame 4 and which is articulated to the base structure 2, for example by means of a ball joint 14 or other equivalent device, and by at least one pair of front supporting arms 15a, 15b which extend outward from the front supporting element 12 and which support, at their opposite end from the end connected to the front supporting element 12, the front resting elements 9a, 9b.

The rear part 7 of the contact frame 4 comprises, instead, at least one rear supporting element 13, which is arranged substantially at the longitudinal axis of extension 4a of the contact frame 4 and which is connected to the base structure, preferably by means of fixing means.

At least one pair of rear supporting arms 16a, 16b and at least one pair of intermediate supporting arms 17a, 17b extend from the rear supporting element 13, in the opposite direction with respect to the longitudinal axis of extension 4a of the frame 4.

In particular, the rear supporting arms 16a and 16b extend inclined, with respect to the longitudinal axis of extension 4a of the frame 4, and downward and rearward, with respect to the body of the horse, while the intermediate supporting arms 17a, 17b extend inclined with respect to the longitudinal axis of extension 4a of the frame 4 and downward and forward with respect to the body of the horse.

In particular, the rear supporting arms 16a, 16b support, at their end opposite to the end connected to the rear supporting element 13, the rear resting elements 10a, 10b, while the intermediate supporting arms 17a and 17b support, in turn, at their end opposite to the end connected to the rear supporting element 13, the intermediate resting elements 11a, 11b.

It should be noted that each one of the intermediate supporting arms 17a, 17b extends rigidly from the rear supporting element 13 toward a respective lateral region interposed between the rear resting elements 10a, 10b and the front resting elements 9a, 9b, as can be seen in FIG. 3.

It should likewise be observed that the contact frame 4 is arranged, advantageously, so as to be in the retracted position, toward the rear part of the horse, with respect to the withers, so avoiding the problems normally caused in traditional saddles by the saddlebow coming into contact with the withers.

According to the embodiment shown, the elastic means 8 are interposed between the front supporting element 12 and the intermediate supporting arms 17a, 17b.

Again according to the embodiment shown, the front supporting element 12 supports at least one pair of connecting arms 21a, 21b, which are fixed, at one end, to the front supporting element 12 and are each connected, at the opposite end, to a portion of a respective intermediate supporting arm 17a, 17b, by means of the interposition of the elastic means 8.

In this case, the elastic means 8 conveniently comprise, for each one of the connecting arms 21a, 21b, at least one respective insert 22 made of elastically yielding material which is interposed between the corresponding connecting arm 21a, 21b and the corresponding intermediate supporting arm 17a, 17b.

By virtue of the connection of the front supporting element 12 with the intermediate supporting arms 17a, 17b by means of the connecting arms 21a, 21b and the inserts 22, the articulation movements of the front part 6 of the contact frame 4 with respect to the base structure 2, defined by the ball joint 14, are, at least in part, elastically contrasted by the elastic reaction of the inserts 22, thus enabling the front part 6 of the contact frame 4 to constantly adjust its position when the horse moves about, and allowing the saddle to remain resting correctly on the back of the horse, and, also, the loads acting on the front part of the contact frame 4 are damped and in part transmitted to the rear part 7 of the contact frame 4, thus ensuring an optimal distribution of forces between the saddle and the horse.

With reference to FIG. 3, it can be seen that each one of the connecting arms 21a, 21b has a first portion of extension, which extends from the front supporting element 12 in the direction of the rear supporting element 13, optionally and not necessarily progressively further away from the longitudinal axis of extension 4a of the contact frame 4, and a second portion of extension, which is connected to the corresponding intermediate supporting arm 17a, 17b by means of the respective insert 22, and which extends substantially at right angles to the corresponding intermediate supporting arm 17a, 17b.

It should be noted that the connecting arms 21a, 21b can extend starting from a same point or from different points, with respect to the front supporting element 12.

It should also be noted that, at the front part of the supporting structure 2, stirrup attachment points 40 can conveniently be fixed, arranged mutually opposite with respect to the longitudinal axis of the supporting structure 2.

It should further be noted that the front resting elements 9a, 9b, on their side directed toward the head of the horse, are conveniently shaped so as to favor the mobility of the shoulder blades of the horse.

Advantageously, it is possible for the base structure 2 and the contact frame 4 to be mutually connected using detachable connection means, so that they can be separated from each other to facilitate the transport of the saddle.

With reference to the embodiment shown in FIGS. 8 to 10, the resting elements 5 are associated with the contact frame 4, and specifically with the respective ends of the supporting arms, by way of interconnection means.

The interconnection means are configured to allow a displacement, in contrast with elastic loading means, along an axial direction of excursion 200 that is substantially perpendicular to the plane of arrangement defined by the respective resting element 5.

The interconnection means are furthermore configured to allow the oscillation of the corresponding resting element 5 with respect to the contact frame 4 about at least one axis, and preferably about multiple, mutually perpendicular axes.

With reference to the embodiment shown in FIGS. 9 and 10, the resting element 5 comprises an internal frame 40 with a perimetric portion 41 that extends substantially along the perimeter of the resting element 5, and is connected to a central core 42.

The central core 42 is connected to the contact frame 4 by an elongated connecting body 31.

The elongated connecting body 31 is preferably made of metallic material.

Preferably, the central core 42 provides a seat, preferably polygonal in cross-section and shaped complementarily to the lateral surface of the elongated connecting body 31, for the lower end, in use, of the elongated connecting body 31.

Advantageously, the elongated element 31 is also polygonal in cross-section at its end that is designed to be associated with the contact frame 4, and in particular with a respective end of the supporting arms.

The supporting arms define a locking seat that is shaped complementarily to the shape of the elongated element 31 so as to allow, in addition to the mutual connection between the elongated element 31 and the respective supporting arm, the locking of the rotation of the elongated element 31 about its own axis of extension.

At least one load transmission element 43 is interposed between the central core 42 and the perimetric portion 41 and is adapted to distribute the forces acting on the central core 42 to the perimetric portion 41 and vice versa.

Advantageously, a plurality of load transmission elements 43 is provided between the central core and the perimetric portion 41 and is arranged radially with respect to an axis that is perpendicular to the plane of arrangement of the perimetric portion 41.

In this manner, any localized stress at the perimetric portion 41 can also be distributed effectively over the entire resting surface.

Advantageously, the transmission elements 43 are constituted by corrugated strips, the width thereof progressively increases starting from the central core 42 and moving toward the perimetric portion 41.

Conveniently, the internal frame 40 is embedded in a containment body 44 made of elastically yielding material.

For the purposes of example, the containment body 44 can be overmolded on the internal frame 40.

According to a further aspect, the present invention relates to a saddle for horses 1 which comprises a base structure 2 designed to be applied on the back of a horse 100 to be saddled.

The base structure 2 defines at least one resting region for a load and, more specifically, a seat 3 for the rider, and has a longitudinal axis of extension that is substantially parallel to the longitudinal extension of the body of the horse 100 to be saddled.

The saddle further comprises a contact frame 4, which in use is interposed between the base structure 2 and the horse 100 to be saddled.

The contact frame 4 extends along a longitudinal axis of extension 4a which is arranged substantially parallel to the longitudinal extension of the body of the horse 100.

In particular, the contact frame 4 supports a plurality of resting elements 5, which are located on opposite sides with respect to the longitudinal axis of extension 4a of the contact frame 4 and which are configured to face the horse in discrete regions, so as to ensure an optimal adaptation of the saddle to the anatomical shape of the horse 100.

The contact frame 4 can have all the characteristics described in the embodiment shown in FIGS. 1 to 7.

The resting elements 5 are associated with the contact frame 4, and specifically with the respective end of the supporting arms, by way of interconnection means.

The interconnection means are adapted to allow a displacement, in contrast with elastic loading means, along an axial direction of excursion 200 that is substantially perpendicular to the plane of arrangement defined by the respective resting element 5.

The interconnection means are furthermore adapted to allow the oscillation of the corresponding resting element 5 with respect to the contact frame 4 about at least one axis, and preferably about multiple, mutually perpendicular axes.

With reference to the embodiment shown in FIGS. 9 and 10, the resting element 5 comprises an internal frame 40 with a perimetric portion 41 that substantially extends along the perimeter of the resting element 5, and is connected to a central core 42.

The central core 42 is connected to the contact frame 4 by an elongated connecting body 31.

The elongated connecting body 31 is preferably made of metallic material.

Preferably, the central core 42 provides a seat, preferably polygonal in cross-section and shaped complementarily to the lateral surface of the elongated connecting body 31, for the lower end, in use, of the elongated connecting body 31.

Advantageously, the elongated element 31 is also polygonal in cross-section at its end that is designed to be associated with the contact frame 4, and in particular with a respective end of the supporting arms.

The supporting arms define a locking seat that is shaped complementarily to the shape of the elongated element 31 so as to allow, in addition to the mutual connection between the elongated element 31 and the respective supporting arm, the locking of the rotation of the elongated element 31 about its own axis of extension.

At least one load transmission element 43 is interposed between the central core 42 and the perimetric portion 41 and is adapted to distribute the forces acting on the central core 42 to the perimetric portion 41 and vice versa.

Advantageously, a plurality of load transmission elements 43 is provided between the central core and the perimetric portion 41 and is arranged radially with respect to an axis that is perpendicular to the plane of arrangement of the perimetric portion 41.

Advantageously, the transmission elements 43 are constituted by corrugated strips the width thereof progressively increases starting from the central core 42 and moving toward the perimetric portion 41.

Conveniently, the internal frame 40 is embedded in a containment body 44 made of elastically yielding material.

According to another possible embodiment, for example shown in FIG. 8, the contact frame 4 can be made starting from elongated tubular elements.

The operation of the saddle according to the invention is the following.

Once the saddle is applied on the back of the horse, the resting elements 5, by virtue of elastic joints 20, are brought to rest correctly on the horse.

Furthermore, during the locomotion of the horse, the front part 6 of the contact frame 4 is able to follow the movements of the horse because it can rotate about the ball joint 14, so as to keep the position of the base structure 2 stable, and, by virtue of the elastic means 8, interposed between the front part 6 and the rear part 7 of the contact frame 4, the loads that are transmitted between the base structure 2 and the horse are distributed uniformly over the entire base frame and are adequately damped.

In practice it has been found that the invention fully achieves the intended aim and objects by providing a saddle for horses that can easily adapt to the anatomical shape of the horse to be saddled.

Another advantage of the invention is that it provides a saddle that is capable of adapting perfectly to the movements of the horse, while at the same time ensuring an optimal distribution of the loads and optimal stability for the rider.

It should also be noted that the fact of having the interconnection between the front part and the rear part of the contact frame makes it possible, when the rider is simply seated on the base structure of the saddle, to transmit at least some of the weight of the rider also onto the front part of the back of the horse and, when the rider shifts their weight to the stirrups, to transmit at least some of the weight of the rider also onto the rear part of the back of the horse.

Then, by virtue of the fact that the base structure can be separated from the contact frame of the saddle according to the invention, it is possible to substitute the base structure, according to requirements of the rider, or the base frame, depending on the horse to be saddled. The invention, thus conceived, is susceptible of numerous modifications and variations, all of which are within the scope of the appended claims.

So, for example, with the same concept, saddles can be provided to be used on pack horses, where the base structure is configured to support, at the resting region of the load, goods or other material to be transported.

Moreover, all the details may be substituted by other, technically equivalent elements.

In practice, the materials used, as well as the contingent shapes and dimensions, may be any according to the requirements and to the state of the art.

The disclosures in Italian Patent Application No. 102023000011547 from which this application claims priority are incorporated herein by reference.

1-11. (canceled)

12. A saddle for horses, comprising a base structure, which defines at least one resting region for a load, and at least one contact frame having a longitudinal axis of extension which is configured to be arranged substantially parallel to a longitudinal axis of the body of the horse and is interposed, in use, between said base structure and the horse to be saddled, said at least one contact frame supporting a plurality of resting elements located on opposite sides with respect to the longitudinal axis of extension of said contact frame and configured to face the horse in discrete regions, said contact frame comprising at least two parts which are arranged along the longitudinal axis of extension of said contact frame and support respective resting elements, at least one of said parts being movable relative to said base structure and being interconnected to another one of said parts by means of the interposition of elastic means and said resting elements being elastically movable, with respect to said contact frame, in order to accommodate movements of the horse during locomotion of the horse and adapt to the anatomy of the horse.

13. The saddle according to claim 12, wherein said parts comprise at least one front part, which is articulated to said base structure and supports at least one pair of front resting elements, which are mutually opposite with respect to the longitudinal axis of extension of said contact frame, and at least one rear part, which is connected to said base structure and supports at least one pair of rear resting elements and at least one pair of intermediate resting elements, which are mutually opposite with respect to the longitudinal axis of extension of said contact frame.

14. The saddle according to claim 13, wherein said front part of said contact frame is articulated to said base structure about multiple mutually perpendicular axes of rotation.

15. The saddle according to claim 13, wherein said front part and said rear part comprise respective supporting elements, which support respective supporting arms, said supporting arms extending laterally away from the longitudinal axis of extension of said contact frame and supporting, at free ends thereof, respective said resting elements.

16. The saddle according to claim 13, wherein said front part comprises at least one front supporting element, substantially arranged at the longitudinal axis of extension of said contact frame and articulated to said base structure, and at least one pair of front supporting arms for respective front resting elements.

17. The saddle according to claim 16, wherein said rear part of said base frame comprises at least one rear supporting element, which is arranged substantially at the longitudinal axis of extension of said base frame and is connected to said base structure, and at least one pair of rear supporting arms for respective rear resting elements and at least one pair of intermediate supporting arms for respective intermediate resting elements.

18. The saddle according to claim 17, wherein said elastic means are interposed between said front supporting element and said intermediate supporting arms.

19. The saddle according to claim 17, wherein said resting elements and said front, rear and intermediate resting elements are connected to the respective supporting arms by means of elastic joints.

20. The saddle according to claim 17, wherein said front supporting element supports at least one pair of connecting arms, which are fixed, at one end, to said front supporting element and are each connected, at an opposite end, to a portion of a respective intermediate supporting arm by means of the interposition of said elastic means.

21. The saddle according to claim 20, wherein said elastic means comprise, for each one of said connecting arms, at least one respective insert made of elastically yielding material which is interposed between the corresponding connecting arm and the corresponding said intermediate supporting arm.

22. The saddle according to claim 20, wherein each one of said intermediate supporting arms extends rigidly from said rear supporting element toward a respective lateral region interposed between said rear resting elements and said front resting elements, said connecting arms each having at least one first portion of extension, which extends from said front supporting element in the direction of said rear supporting element, and a second portion of extension, which is connected to the corresponding intermediate supporting arm by means of the respective insert, and extends substantially at right angles to the corresponding intermediate supporting arm.
